(19) United States
(12) Patent Application Publication
(10) Pub. No.: US 2016/0249152 A1
(43) Pub. Date: Aug. 25, 2016

(54) SYSTEM AND METHOD FOR EVALUATING AN ACOUSTIC TRANSFER FUNCTION

(71) Applicant: Huawei Technologies Co., Ltd., Shenzhen (CN)

(72) Inventors: Wenyu Jin, Wellington (NZ); Willem Bastiaan Kleijn, Eastbourne (NZ); Yue Lang, Beijing (CN); Peter Grosche, Munich (DE)

(21) Appl. No.: 15/142,063

(22) Filed: Apr. 29, 2016

Related U.S. Application Data
(63) Continuation of application No. PCT/EP2013/072833, filed on Oct. 31, 2013.

(51) Int. Cl. H04S 7/00

(52) U.S. Cl. CPC H04S 7/30; H04S 7/301; H04S 2420/01

(57) ABSTRACT

A system and a method for evaluating an acoustic transfer function, wherein the acoustic transfer function is a transfer function from one acoustic source to a reproduction area sampled by a limited number of microphone modules.

### CROSS-REFERENCE TO RELATED APPLICATIONS

This application is a continuation of International Application No. PCT/EP2013/072833, filed on Oct. 31, 2013, which is hereby incorporated by reference in its entirety.

### TECHNICAL FIELD

The present application relates to the field of multi-zone sound reproduction in complex environment, and particularly to a system and a method for evaluating an acoustic transfer function, wherein the acoustic transfer function is a transfer function from one acoustic source to a reproduction area.

### BACKGROUND

U.S. Pat. No. 8,213,637 describes a sound field control in multiple listening regions. A scheme to design an audio pre-compensation controller for a multichannel audio system is provided by the sound field control, with a prescribed number N of loudspeakers in prescribed positions so that listeners positioned in any of P>1 spatially extended listening regions should be given the illusion of being in another acoustic environment that has L sound sources located at prescribed positions in a prescribed room acoustics.

The described method provides a crossover design, a delay and level calibration, a sum-response optimization and an up-mixing. A multi-input multi-output audio pre-compensation controller is designed for an associated sound generating system including a limited number of loudspeaker inputs for emulating a number of virtual sound sources.

U.S. Pat. No. 5,727,066 describes a stereophonic sound reproduction system aimed at synthesizing at a multiplicity of points in the listening space. An auditory effect obtaining at corresponding points in the recording space, to compensate for crosstalk between the loudspeakers, the acoustic response of the listening space, and imperfections in the frequency response of the speaker channels are provided.

Each speaker channel of the described stereophonic sound reproduction system incorporates a digital filter with the characteristics of which are adjusted in response to measurements of the reproduced field. The digital filters of the described stereophonic sound reproduction system are provided by an inverse filter matrix H of which the matrix elements are determined by a least squares technique. A full bandwidth signal is transmitted by a bypass route for combination with the output signal from the filter, the bypass route including a delay means.

### SUMMARY

One object of the present application is to provide an improved technique to measure an acoustic transfer function.

This object is achieved by the features of the independent claims. Further implementation forms are apparent from the dependent claims, the description and the figures.

According to a first aspect, a system for evaluating an acoustic transfer function is provided, wherein the acoustic transfer function is a transfer function from one acoustic source to a reproduction area, the system comprising: a deduction module adapted to subtract a free-field part from an input signal obtaining a measured corrective sound field part; an estimation module adapted to calculate an estimated corrective sound field part based on a weighted series of at least one plane wave, advantageously an over complete set of plane waves, function and a transfer function generation module adapted to generate the acoustic transfer function based on the estimated corrective sound field part and the free-field part.

The system and the method for evaluating an acoustic transfer function provide techniques to measure the acoustic transfer function between the loudspeakers over the reproduction region in complex environments using a limited number of microphones.

The system and the method for evaluating an acoustic transfer function advantageously provide estimating the loudspeaker acoustic transfer function over the entire interested region.

The system and the method for evaluating an acoustic transfer function advantageously provide a solution to reducing the load put on the electro-acoustic system when using crosstalk cancellation for creating an enhanced spatial effect and it facilitates a significant reduction in the number of required microphones for accurate characterization of the acoustic transfer function of a loudspeaker in complex environments.

The system and the method for evaluating an acoustic transfer function further advantageously provide a wide band multi-zone sound reproduction over a frequency range and allow the flexibility of the microphone arrangement. Due to this, the microphones can be randomly placed within the desired region.

Any sound reproduction system with loudspeakers, microphones can be provided with the system. The acoustic transfer function of a loudspeaker is measured in order to control the reproduced sound field around the listeners in complex environments. De-reverberation and room equalization allows removing the influence of the environment on the reproduction and for mobile devices which are used in various and changing environments, the sound reproduction can be improved.

The basic idea of the present invention is introducing a general Green's function modeling approach in complex environments for precisely identifying the acoustic transfer function between the loudspeakers over a reproduction region using a limited number of microphones.

The present invention advantageously provides the solution for a compressed sensing problem and it is based on separating the actual loudspeaker acoustic transfer function into a basic component, the free-field Green's function and a corrective sound field while it is assumed that in the Helmholtz solution domain, i.e. the corrective sound field results from only a relatively small number of basis Helmholtz wave fields (e.g., plane waves).

This sparseness assumption facilitates the finding of the optimal solution that can be used to accurately describe the desired corrective sound over the reproduction region based on a limited number of sound pressure measurements at randomly-selected locations.

In a first possible implementation form of the system according to the first aspect, the deduction module is adapted to use a measurement vector v as the input signal and the measurement vector v is obtained by sampling the reproduction area by a limited number of microphones modules.

The measurement vector v advantageously provides a solution to reducing the load put on the electro-acoustic system.

In a second possible implementation form of the system according to the first implementation form of the first aspect or according to the first aspect as such, the weighted series of at least one plane wave function comprises an evaluated number of plane waves functions selected from a predefined set Φ of basis plane waves functions weighted by the weighting factor r based on sparseness assumption.

This advantageously allows optimizing the solution by weighting.

In a third possible implementation form of the system according to the first aspect as such or according to the any of the preceding implementation forms of the first aspect, the estimation module is adapted to calculate the estimated corrective sound field part based on a measurement vector v.

Advantageously, the measurement vector v is used as a data structure for allowing fastened calculation.

In a fourth possible implementation form of the according to the third possible implementation form of the system according to the first aspect, the non-convex optimization is adapted to solve a weighted l² norm optimization by using iterative reweighted least square algorithm.

Advantageously, iterative reweighted least square algorithm can be used with Gauss-Newton and Levenberg-Marquardt numerical algorithms.

In a fifth possible implementation form of the system according to the third possible implementation form of the first aspect, the non-convex optimization is adapted to estimate an weighting factor r.

This advantageously provides a significant reduction in the number of required microphones for accurate characterization of the acoustic transfer function of a loudspeaker in complex environments.

According to a second aspect, the invention relates to a mobile device comprising a system according to the first aspect as such or according to any of the preceding implementation forms of the first aspect.

According to a third aspect, the invention relates to a teleconferencing device comprising a system according to the first aspect as such or according to any of the preceding implementation forms of the first aspect.

According to a fourth aspect, the invention relates to an audio device comprising a system according to the first aspect as such or according to any of the preceding implementation forms of the first aspect.

According to a fifth aspect, the invention relates to a method for evaluating an acoustic transfer function, wherein the acoustic transfer function is used as a transfer function from one acoustic source to a reproduction area, the method comprising the steps of: subtracting a free-field part from an input signal obtaining a measured corrective sound field part by means of a deduction module, calculating an estimated corrective sound field part based on a weighted series of at least one plane wave function by means of an estimation module; and generating the acoustic transfer function based on the estimated corrective sound field part and the free-field part by means of a transfer function generation module.

In a first possible implementation form of the method according to the fifth aspect, a measurement vector v is used as the input signal and the measurement vector v is obtained by sampling the reproduction area by a limited number of microphones modules.

Thereby, a significant reduction in the number of required microphones for accurate characterization of the acoustic transfer function of a loudspeaker in complex environments is achieved.

In a second possible implementation form of the method according to the first implementation form of the fifth aspect, the weighted series of at least one plane wave function comprises an evaluated number of plane waves functions selected from a predefined set Φ of basis plane waves functions weighted by the weighting factor r based on sparseness assumption.

This advantageously provides a significant reduction in the number of required microphones for accurate characterization of the acoustic transfer function of a loudspeaker in complex environments.

In a third possible implementation form of the method according to the fifth aspect as such or according to the any of the preceding implementation forms of the fifth aspect, the estimation module calculates the estimated corrective sound field part by means of a non-convex optimization.

This advantageously provides a solution to reducing the load put on the electro-acoustic system.

In a fourth possible implementation form of the method according to the third possible implementation form of the method according to the fifth aspect, the non-convex optimization is adapted to solve a weighted l² norm optimization by using iterative reweighted least square algorithm.

Advantageously, iterative reweighted least square algorithm can be used with Gauss-Newton and Levenberg-Marquardt numerical algorithms.

In a fifth possible implementation form of the method according to the third possible implementation form of the method according to the fifth aspect, the non-convex optimization is adapted to estimate an weighting factor r.

The non-convex optimization allows improving the sound reproduction.

The methods, systems and devices described herein may be implemented as software in a Digital Signal Processor, DSP, in a micro-controller or in any other side-processor or as hardware circuit within an application specific integrated circuit, ASIC.

The invention can be implemented in digital electronic circuitry, or in computer hardware, firmware, software, or in combinations thereof, e.g. in available hardware of conventional mobile devices or in new hardware dedicated for processing the methods described herein.

### BRIEF DESCRIPTION OF THE DRAWINGS

Further embodiments of the invention will be described with respect to the following figures, in which:

FIG. 1 shows a schematic diagram of the geometric arrangement as described by acoustic transfer function between a single loudspeaker and a single point according to an embodiment of the invention;

FIG. 2 shows a detailed schematic diagram a sound field reproduction scenario in complex environments using multiple loudspeakers to create a desired sound field in the reproduction area which is measured using several microphones according to an embodiment of the invention;

FIG. 3 shows a flowchart diagram of a method for evaluating an acoustic transfer function, wherein the acoustic transfer function is a transfer function from one acoustic source to a reproduction area according to an embodiment of the invention;

FIG. 4 shows a flowchart diagram of a method for evaluating an acoustic transfer function, wherein the acoustic transfer function is a transfer function from one acoustic source to a reproduction area according to a further embodiment of the invention; and

FIG. 5 shows a schematic diagram of a system for evaluating an acoustic transfer function, wherein the acoustic transfer function is a transfer function from one acoustic source to a reproduction area according to an embodiment of the invention.

### DETAILED DESCRIPTION

In the Figures, identical reference signs denote identical or equivalent elements. In addition, it should be noted that all of the accompanying drawings are not to scale.

The technical solutions in the embodiments of the present invention are described clearly and completely in the following with reference to the accompanying drawings in the embodiments of the present invention.

Apparently, the described embodiments are only some embodiments of the present invention, rather than all embodiments. Based on the embodiments of the present invention, all other embodiments obtained by persons of ordinary skill in the art without making any creative effort shall fall within the protection scope of the present invention.

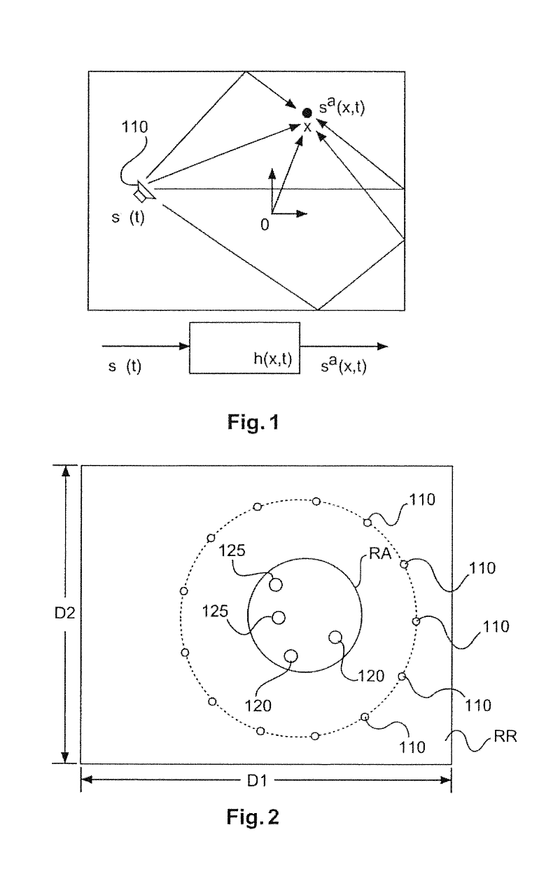

FIG. 1 shows a schematic diagram of the geometric arrangement as described by an acoustic transfer function between a single loudspeaker and a single point according to an embodiment of the invention.

The acoustic transfer function between the loudspeakers over the reproduction region RA in complex environments using a limited number of microphones is illustrated in FIG. 1. The sound field in a reverberant room is normally modeled as a linear and time-invariant system. The actual sound field at a point x with respect to origin point O at time t can be written as a linear function of the signal transmitted by the source s(t) as shown in FIG. 1.

The source is represented by a loudspeaker 110. For a fixed source, the influence of a room with a position-dependent acoustic impulse response h(x; t) can be modeled at each time t:

s^{α}(x; t)=h(x, t)*s(t).

The impulse response h(x; t) is visualized as a box in FIG. 1.

Taking the Fourier transform with respect to wave number k, the acoustic transfer function H(x; k) is defined as the complex gain between the frequency domain quantities of source signal strength s (k) and the actual sound field S^{α}(x; k):

S^{α}(x; k)=H(x; k)s(k).

The sound field S^{α}(x; k) can be written as a weighted series of basis functions that are Helmholtz solutions (the solutions can be non-orthonormal):

$$S ( x , k ) = {\sum }_{n = 1}^{N} {r}_{n} {G}_{n} ( x , k ) , r ∈ {ℂ}^{N}$$

According to the truncation theorem a projection P is defined:

C^{N}→C^{2M+1}(N<<2M+1)

r is a K-sparse signal, the value of K depends on how complicated the reverberant environment is. In our work, we have K≦2M+1, M is the truncation length.

The actual soundfield S^{α}(x; k) may be separated into a basic component, the free-field Green's function and a corrective soundfield R(x, k).

A linear system may be put forward:

v=Φr,

where v contains measurements of the desired corrective soundfield R(x, k) at m randomly chosen location within selected zones and Φ is a m×N (m<<N) over-complete dictionary.

The basis Helmholtz wave field functions in Φ are selected to be plane waves arriving at various angle.

The measured value v is a linear projection of the sparse signal r onto an incoherent basis:

vᵢ= [symbol] ᵢ, r

[symbol]

Iterative reweighted least square is to solve a weighted l² norm optimization:

$${min}_{r} {\sum }_{i = 1}^{N} {w}_{i} {r}_{i}^{2} , s . t . v = Φ r$$

Subsequently, weights are computed from the previous iterate rⁿ^{^{−1}}

wᵢ=((rᵢⁿ⁻¹)²+ε²)^{p/2-1}

The solution of r can be given as

rⁿ=QₙΦ^{H}(ΦQₙΦ^{H})⁻¹v

where Qₙ is the diagonal matrix with entries 1/wᵢ. r⁰ initialized to the minimum 2-norm solution of v=Φ r.

The actual soundfield generated by the loudspeaker over the desired region can be written as:

$$S ( x , k ) = \frac{i}{4} {H}_{0}^{( 1 )} ( k ‖ Y - x ‖ ) + {\sum }_{n = 1}^{N} {\hat{r}}_{n} {G}_{n} ( x , k ) ,$$

where Y represents the position of the loudspeaker.

FIG. 2 shows a detailed schematic diagram a sound field reproduction scenario in complex environments using multiple loudspeakers to create a desired sound field in the reproduction area RA which is measured using several microphones according to an embodiment of the invention.

Optionally, in one embodiment of the present invention, a sound field of the reproduction area RA inside of a reverberant room RR is modeled. The reverberant room RR comprises lateral dimensions D1 and D2, for instance, 8 m and 6 m, respectively. As illustrated in FIG. 2, in a circular arrangement, loudspeakers 110 are placed inside the reverberant room RR.

Multiple microphone modules 120, i.e. at least two microphone modules 120, are provided inside of the reproduction area RA, wherein the microphone modules 120 can be placed on different sites 125 located in the reproduction area RA.

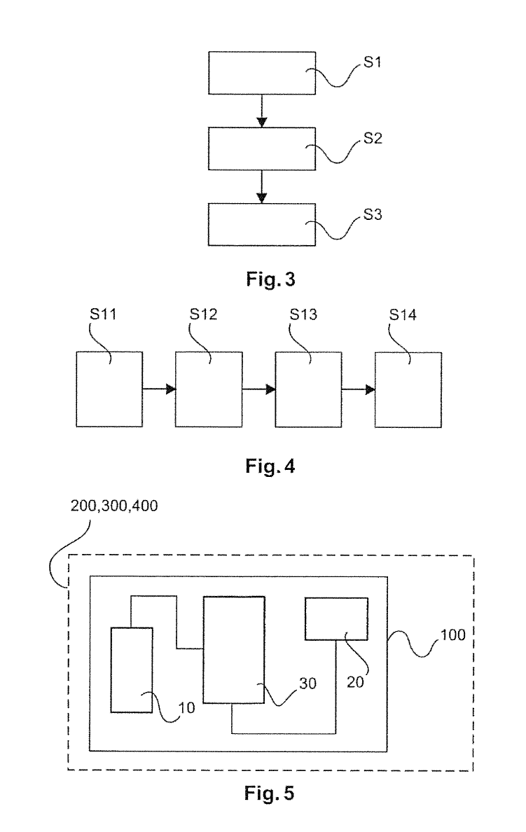

FIG. 3 shows a flowchart diagram of a method for evaluating an acoustic transfer function, wherein the acoustic transfer function is a transfer function from one acoustic source to a reproduction area according to an embodiment of the invention.

The method for evaluating an acoustic transfer function comprises the following steps, wherein the acoustic transfer function is used as a transfer function from one acoustic source to a reproduction area.

As a first step of the method for evaluating an acoustic transfer function, subtracting S1 a free-field part from an input signal is conducted, obtaining a measured corrective sound field part by means of a deduction module 10.

As a second step of the method for evaluating an acoustic transfer function, calculating S2 an estimated corrective sound field part based on a weighted series of at least one plane wave function by means of an estimation module 20 is performed.

As a third step of the method for evaluating an acoustic transfer function, generating S3 the acoustic transfer function based on the estimated corrective sound field part and the free-field part by means of a transfer function generation module 30 is performed.

In an embodiment of the method provided in the present invention, the estimation module may calculate the estimated corrective sound field part by means of a non-convex optimization.

A variety of nonconvex optimization techniques can be used: dual relaxation or sum-of-squares programming through successive SDP—semi definite programming—relaxation, signomial programming through successive GP—Geometric Programming—relaxation, and leveraging the specific structures in problems for efficient and distributed heuristics.

In an embodiment of the method provided in the present invention, the non-convex optimization is adapted to solve a weighted l² norm optimization by using iterative reweighted least square algorithm.

Optionally, in one embodiment of the present invention, method of iteratively reweighted least squares, IRLS, may be used to solve the optimization problem. The method of iteratively reweighted least squares may be used to find the maximum likelihood estimates of a generalized linear model, and in robust regression to find an M-estimator, as a way of mitigating the influence of outliers in an otherwise normally-distributed data set. For example, by minimizing the least absolute error rather than by minimizing the least square error.

In other word, the method for evaluating an acoustic transfer function may be described as follows:

The acoustic transfer function between the loudspeakers over the reproduction region is separated into a basic component, the free-field Green's function and a corrective sound field.

According to one embodiment of the present invention, the weighted series of at least one plane wave function comprises an evaluated number of plane waves functions selected from a predefined set Φ of basis plane waves functions weighted by the weighting factor r based on sparseness assumption:

v=Φr

The ideal free-field solution corresponds to the free-field Green's function over the reproduction area; the corrective sound field corresponds to the sound field which is added by the room as a result of reflections, reverberation. Therefore, the actual measured sound field in the reproduction area corresponds to the superposition of the deterministic free-field sound field and the corrective sound field.

According to one embodiment of the present invention, the method starts by using an input signal from at least one microphone module, subsequently subtracting the deterministic free-field part of sound field. Afterwards, an estimation of the corrective sound field based on sparseness assumption is performed and a corrective sound field to deterministic free-field part is added to generate the acoustic transfer function.

Accordingly, the acoustic transfer function between the loudspeakers over the reproduction region is obtained.

FIG. 4 shows a flowchart diagram of a method for evaluating an acoustic transfer function, wherein the acoustic transfer function is a transfer function from one acoustic source to a reproduction area according to a further embodiment of the invention.

Since in the Helmholtz solution domain, the corrective sound field results from only a relatively small number of basis Helmholtz wave fields (e.g., plane waves), the sparseness assumption is hold. Therefore, the estimation of corrective sound field was formulated as a compressed sensing problem.

Optionally, in one embodiment of the present invention, various solution methods for the Helmholtz equation describing wave propagation in a domain consisting of several layers can be applied. The solution methods are applicable to problems where the layers have different material parameters, which may also vary smoothly within the subdomains.

The flowchart of the corrective sound field estimation is shown in FIG. 4.

As a first step S11 of the corrective sound field estimation, input data is provided in terms of a measurement vector v and a redundant dictionary Φ:

The measurement vector v contains measurements of the corrective part of the acoustic transfer function of a given source at random locations within selected zones and columns of Φ representing independent plane waves arriving from various angles.

As a second step S12 of the corrective sound field estimation, a non-convex optimization is conducted:

$${min}_{r} {‖ r ‖}_{p}^{p} , s . t . v = Φ r$$

r is called the support of the corrective sound field in the plane wave domain and r is a K-sparse signal K≦2M+1<<N, where M is the truncation length. v is a linear projection of the incoherent basis.

As a third step S13 of the corrective sound field estimation, the estimate of the corrective sound field R(x, k) is derived as a weighted series of plane waves based on r.

Finally, as a fourth step S14 of the corrective sound field estimation, R(x, k) is added to the deterministic free-field part.

FIG. 5 shows a schematic diagram of a system for evaluating an acoustic transfer function, wherein the acoustic transfer function is a transfer function from one acoustic source to a reproduction area according to an embodiment of the invention.

The system 100 for evaluating an acoustic transfer function may comprise a deduction module 10, an estimation module 20, and a transfer function generation module 30.

The sound field generated by at least one acoustic source to a reproduction area RA is sampled by a limited number of microphone modules 120.

Optionally, in one embodiment of the present invention, the system 100 for evaluating an acoustic transfer function may be coupled with or provided to or integrated in a mobile device 200, or to a teleconferencing device 300, or to an audio device 400.

In other words, the term “integrated in” means that the system 100 is assembled in a housing or in a covering of the mobile device 200 or the teleconferencing device 300 or the audio device 400.

The deduction module 10 may be adapted to subtract a free-field part from an input signal obtaining a measured corrective sound field part.

The estimation module 20 may be adapted to calculate an estimated corrective sound field part based on a weighted series of at least one plane wave functions.

The transfer function generation module 30 may be adapted to generate the acoustic transfer function based on the estimated corrective sound field part and the free-field part.

The units and modules of the system as described herein, for instance the deduction module 10 and/or the estimation module 20 and/or the transfer function generation module 30 may be realized by electronic circuits or by integrated electronic circuits or by monolithic integrated circuits, wherein all or some of the circuit elements of the circuit are inseparably associated and electrically interconnected.

Optionally, in one embodiment of the present invention, the deduction module 10 may be adapted to use a measurement vector v as the input signal and wherein the measurement vector v is obtained by sampling the reproduction area by a limited number of microphones modules.

According to another embodiment of the present invention, the weighted series of at least one plane wave function may comprise an evaluated number of plane waves functions selected from a predefined set Φ of basis plane waves functions weighted by the weighting factor r based on sparseness assumption.

Optionally, the estimation module 20 may be adapted to calculate the estimated corrective sound field part by means of a non-convex optimization.

Optionally, in one embodiment of the present invention, the non-convex optimization may be adapted to solve a weighted l² norm optimization by using Iterative Reweighted Least Square algorithm.

In another embodiment of the present invention, the non-convex optimization may be adapted to estimate weighting factor r.

The present disclosure also supports a computer program product including computer executable code or computer executable instructions that, when executed, causes at least one computer to execute the performing and computing steps described herein.

Many alternatives, modifications, and variations will be apparent to those skilled in the art in light of the above teachings. Of course, those skilled in the art readily recognize that there are numerous applications of the invention beyond those described herein.

While the present invention has been described with reference to one or more particular embodiments, those skilled in the art recognize that many changes may be made thereto without departing from the scope of the present invention. It is therefore to be understood that within the scope of the appended claims and their equivalents, the inventions may be practiced otherwise than as specifically described herein.

In the claims, the word “comprising” does not exclude other elements or steps, and the indefinite article at or “an” does not exclude a plurality. A single processor or other unit may fulfill the functions of several items recited in the claims.

The mere fact that certain measures are recited in mutually different dependent claims does not indicate that a combination of these measured cannot be used to advantage.

A computer program may be stored or distributed on a suitable medium, such as an optical storage medium or a solid-state medium supplied together with or as part of other hardware, but may also be distributed in other forms, such as via the Internet or other wired or wireless telecommunication systems.

What is claimed is:

1. A system for evaluating an acoustic transfer function, wherein the acoustic transfer function is a transfer function from one acoustic source to a reproduction area, the system comprising:
a deduction module adapted to subtract a free-field part from an input signal obtaining a measured corrective sound field part;
an estimation module adapted to calculate an estimated corrective sound field part based on a weighted series of at least one plane wave function; and
a transfer function generation module adapted to generate the acoustic transfer function based on the estimated corrective sound field part and the free-field part.

2. The system according to claim 1, wherein the deduction module is adapted to use a measurement vector v as the input signal and wherein the measurement vector v is obtained by sampling the reproduction area by a limited number of microphones modules.

3. The system according to claim 1, wherein the weighted series of at least one plane wave function comprises an evaluated number of plane waves functions selected from a predefined set Φ of basis plane waves functions weighted by the weighting factor r based on sparseness assumption.

4. The system according to 1, wherein the estimation module is adapted to calculate the estimated corrective sound field part by means of a non-convex optimization.

5. The system according to claim 4, wherein the non-convex optimization is adapted to solve a weighted l² norm optimization by using iterative reweighted least square algorithm.

6. The system according to claim 4, wherein the non-convex optimization is adapted to estimate an weighting factor r.

7. A mobile device comprising a system according to claim 1.

8. A teleconferencing device comprising a system according to claim 1.

9. An audio device comprising a system according to claim 1.

10. A method for evaluating an acoustic transfer function, wherein the acoustic transfer function is used as a transfer function from one acoustic source to a reproduction area, the method comprising:
subtracting a free-field part from an input signal obtaining a measured corrective sound field part by means of a deduction module;
calculating an estimated corrective sound field part based on a weighted series of at least one plane wave function by means of an estimation module; and
generating the acoustic transfer function based on the estimated corrective sound field part and the free-field part by means of a transfer function generation module.

11. The method according to claim 10, wherein a measurement vector v is used as the input signal and wherein the measurement vector v is obtained by sampling the reproduction area by a limited number of microphones modules.

12. The method according to claim 10, wherein the weighted series of at least one plane wave function comprises an evaluated number of plane waves functions selected from a predefined set Φ of basis plane waves functions weighted by the weighting factor r based on sparseness assumption.

13. The method according to claim 10, wherein the estimation module calculates the estimated corrective sound field part further by means of a non-convex optimization.

14. The method according to claim 13, wherein the non-convex optimization is adapted to solve a weighted l² norm optimization by using iterative reweighted least square algorithm.

15. The method according to claim 13, wherein the non-convex optimization is adapted to estimate a weighting factor r.
